(19) United States
(12) Patent Application Publication
(10) Pub. No.: US 2015/0089919 A1
(43) Pub. Date: Apr. 2, 2015

(54) SYSTEM AND METHOD FOR ECOLOGICALLY GENERATING AND STORING ELECTRICITY

(71) Applicant: Helmholtz-Zentrum Potsdam Deutsches GeoForschungs -Zentrum - GFZ Stiftung des Oeffentlichen Rechts, Potsdam (DE)

(72) Inventor: Michael Kuehn, Berlin (DE)

(21) Appl. No.: 14/395,605

(22) PCT Filed: Apr. 19, 2013
(86) PCT No.: PCT/EP2013/058209

§ 371 Date: Oct. 20, 2014

(30) Foreign Application Priority Data
Apr. 19, 2012 (DE) 102012103458.3

(51) Int. Cl. F02B 63/04; F02B 43/12; C25B 1/04

(52) U.S. Cl. CPC F02B 63/04; C25B 1/04; F02B 43/12; F02B 2043/106
USPC 60/39.12; 60/772

(57) ABSTRACT

The present invention refers to a system for the production and storage of surplus energy from regenerative power sources in the form of hydrocarbons, which can be used in a closed cycle for renewed environment-friendly power production by the recycling of waste gas products.

The system 1 has
a facility 2 for the production of power by the combustion of hydrocarbons,
a facility 3 for the production of hydrocarbons from hydrogen and carbon dioxide
a repository 4 with carbon dioxide
a repository 5 with hydrocarbons, whereby
   the facility (2) for the production of power with at least one line each (6, 7) connected to the repository (4) containing carbon dioxide and repository (5) with hydrocarbons, and
   the facility (3) for the production of combustible hydrocarbons with at least one line (8) connected to the repository (5) containing hydrocarbons.

Process, characterized by the following steps:
a) Production of hydrocarbons such as methane by a reaction between carbon dioxide and hydrogen,
b) Combustion of the hydrocarbons produced in step a) with the release of carbon dioxide,
c) Recycling the carbon dioxide produced in step b) back to step a) and/or storing the carbon dioxide in a repository provided for that purpose.

The present invention relates to a system for the production and storage of surplus energy from regenerative power sources in the form of hydrocarbons, which can be used in a closed cycle for renewed environment-friendly power production by the recycling of waste gas products.

The power system in Germany and Europe up to now been so structured that the load curve is largely followed by large power plants which are mostly thermal stations. The principle of power production in thermal power plants is based on the conversion of thermal energy into electrical power. The thermal energy is produced by the combustion of organic materials, as a rule fossil fuels such as coal, mineral oil or natural gas. Other materials can however, in principle, also be used which produce heat when they are burned. Refuse incineration plants are examples of this. Heat released during combustion generates steam from water and drives a steam turbine, which then converts the kinetic energy into electric power.

One problem with the combustion of organic fuels is the formation of carbon dioxide (CO₂). CO₂ is a gas which strongly absorbs the infrared radiation in sunlight, held to be responsible for global warming of the Earth's atmosphere—also known as the “greenhouse effect”.

A further problem is the utilization of the fossil fuels themselves, as these are the waste products of dead animals and plants from previous geological eras and, in contrast to renewable resources such as wood, cannot be regenerated—at least not within the time horizon of the human race. An end to these fossil fuel resources is therefore foreseeable.

Power plants driven by regenerative energy are therefore becoming increasingly important. The term regenerative energy is understood as energy from sources which can themselves be renewed either in the short term or their use does not contribute to the exhaustion of the source. These renewable energies include especially wind energy, solar energy, hydroelectric power, geothermal heat and energy from the tides.

The disadvantage with solar and wind power plants is that these depend on the availability of an energy source that can be subject to large fluctuations. For instance solar power plants, for obvious reasons, can only produce appreciable power during the day when there is sufficient solar radiation and wind generators only when there is sufficient wind. Meeting the power requirement at at all times can therefore not be achieved by these power plants alone.

A disadvantage of non-material energy resources lies in their own nature, as these cannot directly store energy because of their non-material character. Just as excess energy produced as electrical power cannot be directly stored as such. On the contrary, a material storage medium is required that is transformed by electrical energy and so absorbs energy by means of the transformation. In the reconversion to the original state, the stored energy is released again and can be used. A material aid is therefore needed for the storage of solar or wind energy.

A process for the storage of electrical energy is known from U.S. Pat. No. 4,189,925 A. A system is described there in which electrolysis is used to generate hydrogen from water so that hydrocarbons such as methane or methanol can be generated from a carbon source such as carbon dioxide. These hydrocarbons are then stored in a repository and can be used as needed for the generation of electric power.

Also known from US 2009/0289227 A1 is a process in which CO₂, arising as waste gas stream in the use of carbon-containing substances, is used for the production of substances such as methane, methanol or carbon monoxide, which can be used as fuels. In this, power from regenerative sources, (e.g. wind power) is used to manufacture hydrogen, which can among other things be used for the manufacture of organic substances.

DE 10 2011 013 922 A1 describes a process for the storage of surplus energy in a complex system of different power station types.

DE 20 2011 005 536 U1 discloses a plant for the use of time-varying carbon dioxide production from various energy sources.

In DE 20 2010 012 734 U1, an energy carrier-production plant for carbon dioxide-neutral equalization of production peaks and valleys is described whereby liquid fuels such as methanol can be used to transport the energy.

DE 10 2009 018 126 A1 relates to an energy supply system and operating method in which methane gas produced is fed into a gas supply network.

U.S. Pat. No. 5,505,824 A discloses a facility and process for producing fuels such as methane from atmospheric carbon dioxide, which can then be used in rocket propulsion systems or combustion engines.

A central disadvantage in the known use of hydrocarbons such as methane or methanol for energy storage is that in its reconversion to power or heat, CO₂ released again has the already well-known effect on the climate.

It would therefore be desirable to have energy production or storage based on hydrocarbons which avoids the above mentioned disadvantages.

The task of the present invention is therefore to make available a local, tightly-coupled process for the production of power and the storage of by-products such as CO₂ which is both environment-friendly and efficient and from which the atmosphere is polluted as little as possible by the carbon dioxide that is released.

The task is solved by a system that accords with the features of the main claim and a method according to the independent process claim. Further beneficial implementations are given in the sub-claims.

The subject of the present invention is therefore a system 1 having
a facility 2 for the production of power by the combustion of hydrocarbons,
a facility 3 for the production of hydrocarbons from hydrogen and carbon dioxide
a repository 4 with carbon dioxide
a repository 5 with hydrocarbons,
   whereby the facility 2 for the production of electrical power which is connected to repository 4 containing carbon dioxide and repository 5 containing hydrocarbons by at least one line each, and facility 3 for the production of combustible hydrocarbons with at least one line 8 connected to repository 5 containing hydrocarbons.

According to the present invention, especially preferred is a system 1, in which at least one of the repositories 4 or 5 is underground.

According to the present invention, very especially preferred is a system 1 in which the two repositories 4 and 5 are each underground repositories.

Especially preferred in this are underground repositories, each of which can be selected independently of the other and are porous repositories, aquifer repositories, depleted reservoirs or cavern repositories.

According to the present invention, preferred is that the system 1 also has a facility 9 for the production of hydrogen that is connected to the facility 3 for the production of hydrocarbons. In this is also preferred that there is a provision for a facility 10 for the production of electricity that is connected to the facility 9 for the production of hydrogen. In this is also especially preferred that the facility 10 for the production of electricity does so by producing this from renewable energy sources such as wind, sun, hydroelectric or geothermal.

Especially preferred is also a system 1, whereby facility 2 for the production of electricity is a gas and steam turbine (combined cycle) power station.

According to the present invention, preferred is also a system 1 whereby at least one of the repositories 4 and 5 is underground. Especially preferred is that both repositories 4 and 5 are underground.

Especially preferred is also that the system 1 has a biogas plant 11 for the production of volatile hydrocarbons such as methane from biomass and is connected by line 12 to the repository 5 for hydrocarbons.

According to the present invention, preferred is also a system 1 whereby the repository 4 with carbon dioxide is connected by a line 13 to the facility 3 for the production of hydrocarbons from hydrogen and carbon dioxide.

Subject matter of the present invention is also a process with which the following steps are performed:
a) Production of hydrocarbons such as methane by a reaction between carbon dioxide and hydrogen.
b) Combustion of the hydrocarbons produced in step a) with the release of carbon dioxide.
c) Recycling the carbon dioxide produced in step b) to step a) and/or storing the carbon dioxide in a repository provided for that purpose.

A provision is made here that the hydrocarbons produced are directly subjected to combustion without intermediate storage of the hydrocarbons.

Preferred is a process whereby the energy released in step b) is used to produce electricity, preferably by means of a gas-steam (combined-cycle) turbine power station.

Especially preferred is also a process whereby hydrogen in step a) is produced by the electrolysis of water. According to the present invention, especially preferred is that the power for the electrolysis is produced by renewable energy such as wind, sun, hydroelectric or geothermal.

An essential feature of the present invention is that, during the combustion, CO₂ released is not given off to the atmosphere but captured and deposited in a repository from which it is used, depending on the need, for the production of hydrocarbons such as methane (methanation). In this way, a cycle is produced in which CO₂ is alternately produced and reconverted to hydrocarbon compounds.

This means that CO₂, which is otherwise only regarded as a waste gas, can be used as a raw material for the manufacture of an energy store in material form. The CO₂ cycle can be represented by the example of methane as hydrocarbon using the reaction equations as follows:

I) Methanation:

4H₂+CO₂−>CH₄+2H₂O (I)

II) Combustion:

CH₄+O₂−>CO₂+H₂O (II)

In step (I), methane is generated from hydrogen and carbon dioxide. This is burned again in step (II) in the facility for the production of electricity and converted to carbon dioxide which is then either stored or returned directly to the methanation in step (I).

The methanation can be performed for example according to the well-known Sabatier process at temperatures between 300° C. and 700° C. in the presence of a nickel catalyst.

The CO₂ can for example be isolated in a so-called oxy-fuel process. In this, the fuels are burned in a pure oxygen atmosphere. The pure oxygen can in turn be taken from the plant for the production of hydrogen as oxygen is also, in addition to hydrogen, formed during the electrolysis of water. In contrast to the case with air, there is no nitrogen present so that the flue gases generated comprise almost 100% CO₂ and steam. The steam can be easily condensed by cooling so that pure or highly concentrated CO₂ remains, which can be compressed and transported to the repository.

This means that CO₂ and CH₄ form a cycle and do not leave the reaction system or system 1 according to the present invention. The hydrogen required for the methanation is produced using power from the regenerative energy sources and forms an output product for the manufacture of methane. This makes available a CO₂-neutral energy producing system, which itself supplies no additional CO₂.

The energy storage based on hydrocarbons is especially suitable for local gas and steam turbine power stations (combined cycle, abbreviated to CCPP) which can be optimally combined with the CCS technology. CCS stands for Carbon Dioxide Capture and Storage, which means the storage of carbon dioxide in repositories in underground rock formations. This technology is especially suitable for CCPPs as methane is normally used as the fuel and CCPPs with an efficiency of approx. 60% are very efficient and scalable.

CCPP power stations have also the advantage that they can be started up and shut down quickly. This makes the power stations profitable as they can offer electric power on the regular energy market in the range of minute reserve. The power from CCPP stations can also be scaled in the range 80 MW to 860 MW per unit. This makes the present invention-related process and the system also profitable for smaller public utilities and contributes to delocalization and so to the controllability of electricity production.

The hydrogen needed for the production of hydrocarbons can be produced by electrolysis of water according to the following equation:

2H₂O−>2H₂+O₂ (III)

Electricity from regenerative sources can be used in an advantageous way for the production of hydrogen by the electrolysis of water. As already mentioned, surplus energy cannot readily be stored. It therefore makes sense to use surplus regenerative electrical energy for the production of hydrocarbons as the excess energy can be so used in the form of a material energy store and is not lost.

The resulting generation of oxygen as a by-product can also be used to advantage for the combustion in reaction (II). It therefore makes special sense if the combustion is operated using the oxyfuel process in which, as already mentioned, pure oxygen is required. In this way, the by-products formed can also be meaningfully utilized.

The hydrocarbons formed are either burned directly in the facility for the production of electrical power or stored in a hydrocarbon repository. The hydrocarbon repository is connected to the power plant via a borehole or a line so that the hydrocarbons can also be taken from the hydrocarbon repository. The hydrocarbon repository is used to store surplus hydrocarbons should they not be required immediately for the production of electricity.

A material-based energy storage on the basis of hydrocarbons has several important advantages over hydrogen storage:
i) It can be quickly implemented as the hydrogen storage in geological repositories is not yet state-of-the-art.
ii) The reconversion of methane into electricity can draw on established power plant technology.
iii) The hydrocarbons can the fed into the existing natural gas grid.
iv) In contrast to hydrogen, the storage of hydrocarbons is already state of the art.

The storage of methane and other hydrocarbons as well as the storage of carbon dioxide in underground repositories is well known as state of the art. In the case of underground repositories, a difference is drawn between porous storage with its two variants, namely aquifer storage and depleted repositories (hydrocarbons, crude oil, oil shale) on the one hand and cavern storage, especially technically constructed cavities in salt formations, on the other.

The underground storage can be provided in various geological formations. These formations occur frequently, also in Germany, and allow such storage to be provided at different depths one underneath the other.

The system related to the present invention can also contain a biogas plant. Biogas plants are used for the production of biogas by the fermentation of biomass whereby utilizable hydrocarbons such as methane can also be formed. This can be collected and fed to the facility by means of a borehole or line for the production of electricity. The biogas plant therefore represents an alternative methane source as a fallback should the production of hydrocarbons from CO₂ not be possible for any reason.

With the plant related to the present invention, thermal power plants and solar power plants can, for example, be operated alternately. During the day, excess energy from the stronger solar radiation can be stored in the form of methane, which is then used to drive the thermal power plant during the night when there is no sunshine.

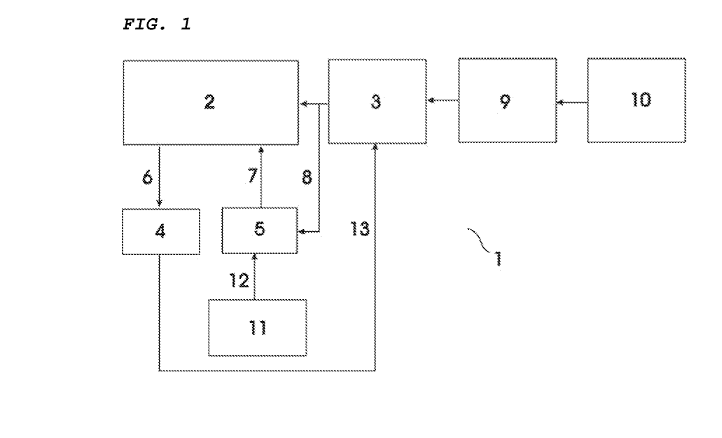

The present invention is explained using the following implementation example. For this, FIG. 1 shows a schematic representation of the system related to the present invention.

The system 1 comprises a facility 2 for the production of electricity, e.g. thermal power plant, a facility 3 for the production of hydrocarbons, a repository 4 for carbon dioxide and a repository 5 for the hydrocarbons produced. The repository 4 is connected by a line 6 to the facility 2 and a further line 13 to the facility 3. A pipeline 7 also connects the facility 2 to the repository 5 for hydrocarbons.

Electrolysis (i.e. with the help of electrical power) is used in the facility 9 to split water into its components hydrogen (H₂) and oxygen (O₂). The hydrogen formed is then transported to the facility 3 where carbon dioxide together with the hydrogen produced is reduced to hydrocarbons, e.g. methane.

The hydrocarbons produced are now either transported directly to the facility or, should an excess of methane be present, stored in a methane repository 5 provided for that. The possibility for directly feeding the hydrocarbons produced to the facility 2 is an important advantage of the system related to the present invention and its invention-related process. With that, it is namely possible that the carbon dioxide formed in the combustion can again be directly fed into the facility 3 for the production of hydrocarbons. With that, the climate-relevant carbon dioxide is recycled and cannot escape to the atmosphere.

In the thermal power plant, the hydrocarbons are optionally mixed with other fossil fuels and burned; the resulting heat is converted into electricity.

The carbon dioxide released during the combustion of hydrocarbons is separated from the other gaseous components, transported via line 6 to the carbon dioxide repository 4 and deposited there. The carbon dioxide can, if needed, be transferred from there via line 13 to the facility 3 for production of hydrocarbons.

The facility 2 for the production of electricity, the carbon dioxide repository 4 and the facility 3 for the production of methane form a cycle in which the carbon dioxide circulates between the facility 2 for the production of electricity, the repository 4 for carbon dioxide and the facility 3 for the production of methane. As the carbon dioxide does not get into the environment, the carbon dioxide content in the atmosphere is not increased. The process therefore represents an environment-friendly method of energy generation and storage which can be adapted to particular requirements.

The hydrogen required for the production of hydrocarbons is generated in facility 9 by electrolyzing water. The electrical power required for this comes from facility 10, e.g. a wind power plant.

The carbon dioxide repository 4 is also connected via line 12 to a biogas plant 11 in which biomass is fermented and forms volatile hydrocarbons. This is collected and transported via line 12 to the repository 5 for hydrocarbons. In this way, additional hydrocarbons are produced which can be used for the production of electricity as fuel in facility 2.

In addition, the biogas plant 11 is connected via line 14 to the facility 3 for the production of hydrocarbons. The CO₂ occurring in the biogas plant 11 can be transported via line 14 to the facility for the production of methane.

The system and the process related to the present invention are especially suitable for application in local, closely-coupled, energy producing plants which work using renewable energy generation facilities. The combination of wind energy, solar energy and energy from biomass, coupled with a gas-steam combined-cycle power plant, form a supply facility for small to medium-sized communal units which is independent of energy supplies from outside. No fossil fuels are required to ensure a reliable energy supply. In addition to the direct supply of electrical power, hydrocarbons can also be fed to the end consumers via a gas supply grid. The energy is therefore produced where it is required. The connection to long-distance energy pipelines is not necessary. Surplus energy that has been produced will be stored in the form of hydrocarbons. These hydrocarbons can in turn be simply transported or stored.

### REFERENCE NUMBER LIST

1 System

2 Facility for producing electrical power

3 Facility for producing hydrocarbons

4 Repository for carbon dioxide

5 Repository for hydrocarbons

6 Line

7 Line

8 Line

9 Facility for producing hydrogen

10 Facility for producing electrical power

11 Biogas plant

12 Line

13 Line

14 Line

1. System (1), comprising
a facility (2) for the production of electrical power by the combustion of hydrocarbons
a facility (3) for the production of hydrocarbons from hydrogen and carbon dioxide
a repository (4) with carbon dioxide
a repository (5) with hydrocarbons, characterized in that
the facility (2) for the production of power is connected with at least one line each (6, 7) to the repository (4) containing carbon dioxide and repository (5) with hydrocarbons, and the facility (3) for the production of combustible hydrocarbons with at least one line (8) connected to the repository (5) containing hydrocarbons.

2. System (1), according to claim 1, characterized in that at least one of the repositories 4 or 5 is located underground.

3. System (1), according to claim 1, characterized in that both repositories (4) and (5) are located underground.

4. System (1), according to claim 1, characterized in that one or both underground repositories are independently selected from each other, out of porous repositories, aquifer repositories, depleted reservoirs or cavern repositories.

5. System (1) according to one of claims 1, 2, 3, 4 or 15, further comprising a facility (9) for the production of hydrogen that is connected to the facility (3) for the production of hydrocarbons.

6. System (1) according to claim 5, further comprising a facility (10) for the production of electric power that is connected to the facility (9) for the production of hydrocarbons.

7. System (1), according to claim 6, characterized in that the facility (10) for the production of electricity does produce the electricity from renewable energy sources such as wind, sun, hydroelectric or geothermal.

8. System (1), according to one of claims 1-7 or 15, characterized in that the facility (2) for the production of electricity is a gas and steam turbine (combined cycle) power station.

9. System (1), according to one of claims 1-8 or 15, characterized in that the system (1) further comprises a biogas plant (11) for the production of volatile hydrocarbons such as methane from biomass that is connected by a line (12) to the repository (5) for hydrocarbons.

10. System (1), according to one of claims 1-9 or 15, characterized in that the repository (4) with carbon dioxide is connected by a line (13) to the facility (3) for the production of hydrocarbons from hydrogen and carbon dioxide.

11. Process, characterized by the following steps
a) Production of hydrocarbons such as methane by a reaction between carbon dioxide and hydrogen,
b) Combustion of the hydrocarbons produced in step a) with the release of carbon dioxide,
c) Recycling the carbon dioxide produced in step b) back to step a) and/or storing the carbon dioxide in a repository provided for that purpose.

12. Process according to claim 11, characterized in that the energy released in step b) is used to produce electricity, preferably by means of a gas-steam (combined-cycle) turbine power station.

13. Process according to one of the previous claim 11 or 12, characterized in that the hydrogen in step a) is produced by the electrolysis of water.

14. Process according to claim 13, characterized in that the power for the electrolysis is produced by renewable energy such as wind, sun, hydroelectric or geothermal.

15. System (1), according to claim 1, characterized in that both repositories (4) and (5) are located underground at different depths one underneath the other.
